(19) United States
(12) Patent Application Publication
(10) Pub. No.: US 2014/0062705 A1
(43) Pub. Date: Mar. 6, 2014

(54) Multilevel Signaling System and Method

(71) Applicants: Timothy A. Rauworth, West Chicago, IL (US); Fred Nathan Merkle, Chicago, IL (US); Deborah Renee Taylor, Gilly (CH); Robert J. Selepa, Naperville, IL (US)

(72) Inventors: Timothy A. Rauworth, West Chicago, IL (US); Fred Nathan Merkle, Chicago, IL (US); Deborah Renee Taylor, Gilly (CH); Robert J. Selepa, Naperville, IL (US)

(73) Assignee: Honeywell International Inc., Morristown, NJ (US)

(21) Appl. No.: 13/599,454

(22) Filed: Aug. 30, 2012

(51) Int. Cl. G08B 17/10; G08B 21/00

(52) U.S. Cl. 340/632; 340/540; 340/662

(57) ABSTRACT

A fire detecting system can mix fire detectors, such as smoke, flame, or, thermal detectors on a common loop, or zone, with gas detectors. Signals indicative of gas can have one amplitude while those indicating fire can have a different amplitude. Duty cycles can be varied to indicate other conditions, such as trouble conditions.

### FIELD

The application pertains to detectors and alarm systems where different types of detectors can be readily installed on a common loop or zone. More particularly, the application pertains to such detectors and systems wherein differing signal amplitudes and durations are used to indicate the presence of different conditions.

### BACKGROUND

Installation problems exist at times where a need develops to retrofit a system connected gas detector, for example, a CO detector, into an existing alarm system. An installer may have to pull a multi-conductor cable from the installation point back to the control panel. This process can be both expensive and inconvenient.

It would be useful to be able to install gas detectors, or combination gas and fire detectors on an existing zone or loop with previously installed fire detectors without needing to pull additional wires.

### BRIEF DESCRIPTION OF THE DRAWINGS

FIG. 1 is a block diagram of an embodiment hereof;

FIG. 2A is a graph indicating a first signaling condition; and

FIG. 2B is a different graph indicating a second signaling condition.

### DETAILED DESCRIPTION

While embodiments can take many different forms, specific embodiments thereof are shown in the drawings and will be described herein in detail with the understanding that the present disclosure is to be considered as an exemplification of the principles hereof, as well as the best mode of practicing same. No limitation to the specific embodiment illustrated is intended.

In embodiments hereof, gas detectors can be added to existing fire, wired, detection systems without having to add additional wiring to take into account different signal values associated with detected gases, or trouble indicators from the respective gas detectors. In accordance herewith, the respective gas detectors, or the gas detection portion of a new, or additional, combination gas/fire detector, will clamp, or assert, an open circuit voltage on the loop, for example 12 volts, to a lower voltage, perhaps 10 volts, which is above the expected minimum operating voltage of the fire directors, which may be on the order of 8.5 volts.

Advantageously, both gas alarm signals, and trouble signals associated with gas detectors can be indicated to a respective alarm system control element, or panel, by asserting a single predetermined voltage. A singular amplitude level can be combined with varying duty cycles to indicate either the detected presence of a gas or a trouble condition. Where the selected voltage amplitude is between the loop's normal open circuit voltage and the minimum operating voltage of the associated fire detectors, the gas detector related signaling is transparent to the operation of the associated fire detectors.

In one aspect hereof, additional gas or combination gas/fire detectors can be added to a system of previously installed fire detectors using the same signaling loop. Separate wiring for the gas detectors, or the gas sensing portion of combination gas/fire detectors is not needed. Visual or audible signaling devices, or sounders, coupled to the loop can be activated independently as needed by reversing the polarity of the voltage applied to the loop.

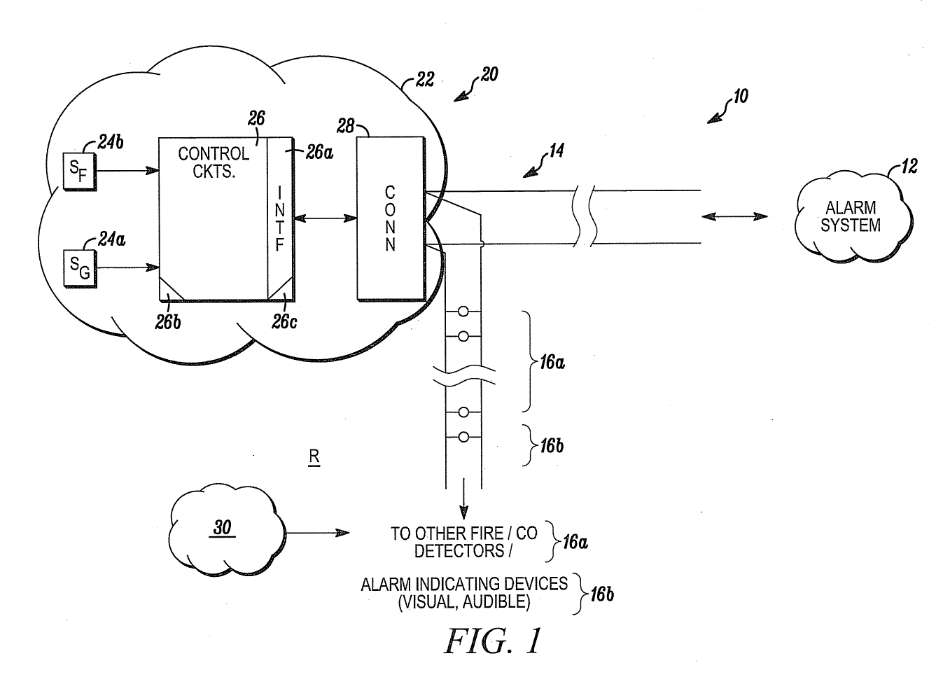

FIG. 1 illustrates an embodiment 10 of a system in accordance herewith. System 10 includes a fire alarm system 12 of a conventional type to which can be coupled a two wire loop 14 which extends into a region R being monitored. Fire detectors along with gas detectors, or combined gas/fire detectors, indicated at 16a, and audible or visual alarm indicating signaling devices, indicated at 16b, can all be coupled to the loop 14.

A representative combination fire and gas detector 20 is illustrated coupled to the loop 14. It will be understood that neither the number of detectors, such as 16a, or 20, nor the number of signaling devices such as 16b which are coupled to the loop 14 are limitations hereof. Further, neither type of fire sensors such as smoke, heat or the like or the type of gas sensors, such as electrochemical, or semiconductor based, are limitations hereof.

Representative detector 20 includes a housing 22 which encloses and carries components such as a gas sensor 24a, and an optional fire sensor 24b. It will be understood that multiple gas or fire sensors can be carried in housing 20 without departing from the spirit and scope hereof.

Control circuits 26 can receive signals from the sensors 24a, b for local processing or analysis. Control circuits 26 can include interface circuitry 26, which could be bidirectional. Connectors 28 coupled to the interface circuits 26a can couple the detector 20 to the loop 14.

The control circuits 26 can be implemented, at least in part, with a programmable processor 26b and associated control software 26c stored on non-volatile memory or storage units in the circuitry 26.

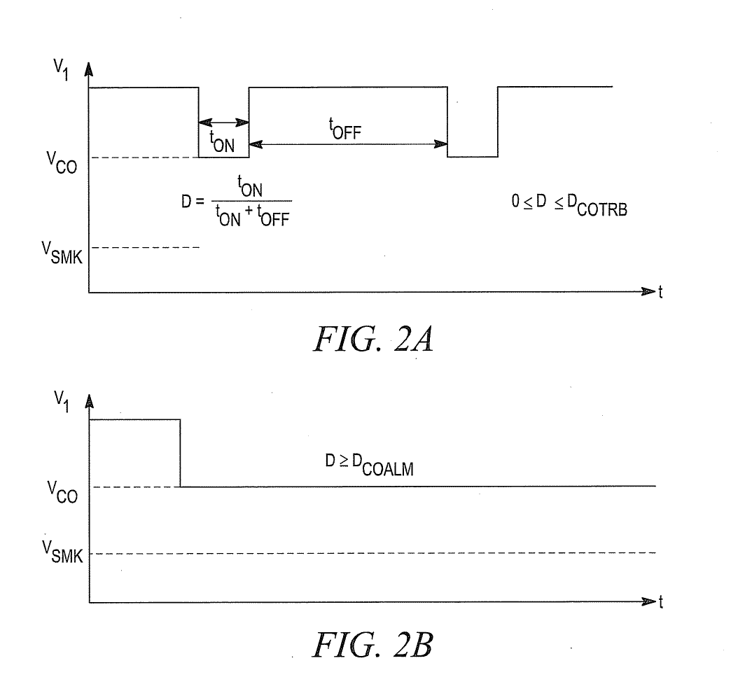

Signaling patterns associated with detector 20 are illustrated in the graphs of FIGS. 2A, 2B. An open circuit voltage V1 can be coupled to loop 14 by the alarm system 12. The particular value of V1 is not a limitation hereof so long as V1 exceeds a minimum voltage Vsmk needed to activate the smoke detectors on the loop 14.

For example, where V1 is on the order of 12 volts and the minimum smoke detector operating voltage is 8-8.5 volts, the voltage amplitude associated with gas sensing functions, Vco can be on the order of ten volts.

Where a fire condition is sensed, at sensor 24b, or at any other smoke detector on the loop 14, the interface 26a, or corresponding circuitry in the detector sensing the fire condition, clamps the voltage on the loop 14 to a value below the smoke indicating threshold at the system 12, for example, 3 volts or less. The presence of the gas sensor 24a and its signaling has no effect on detection of smoke, heat, flames or the like.

At detector 20 gas sensor related signaling asserts a common voltage amplitude Vco, on the loop 14, where either a selected gas such as carbon monoxide is sensed, or the gas sensing portion of detector 20 is exhibiting at trouble condition. Different duty cycles are used to distinguish the presence of a gas trouble condition, from a gas present condition. In FIG. 2A a gas related trouble condition can be indicated to system 12 by pulsing the loop 14, via interface 26a for a time interval less than a predetermined value. Where the duty cycle on the loop 14 is greater than zero, and less than a predetermined value, such as Dcotrb, the system 12 can detect a gas, or CO trouble condition. To assert a gas, or CO alarm, the detector 20 asserts the CO indicating voltage Vco continuously, as in FIG. 2B.

In summary, as described above and illustrates in the figures, a common amplitude value, in combination with predetermined duty cycle thresholds can be used to indicate the presence of gas, or a gas related trouble condition at a detector without impacting operation of the fire detectors present on the loop. Additional gas detectors, such as detector 30, can thus be added to an existing alarm system using the existing loops, and installed fire detectors without needing separate loops, or cable runs for the later installed gas detectors.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims.

1. A detector comprising:
an ambient condition sensor;
control circuits coupled to the sensor; and
wherein the control circuits include an interface where in response to a first condition, the interface exhibits a first output state for a period of time less than a predetermined value, and in response to a detected ambient condition, the interface exhibits the first output state for a period of time greater than the predetermined value.

2. A detector as in claim 1 where the sensor comprises one of at least a fire sensor, or a gas sensor.

3. A detector as in claim 1 which includes a second, different sensor where one sensor is a gas sensor and the other is a fire sensor, where responsive to at least one of the sensors, the interface exhibits one of the first output state or a second, different output state.

4. A detector as in claim 2 where the sensor comprises a gas sensor and in response to the presence of a predetermined gas, the first output state is exhibited for a period of time which exceeds the predetermined time period.

5. A detector as in claim 4 where in response to the first condition, the first output state is exhibited for a period of time less than the predetermined value.

6. A detector as in claim 3 where in the presence of an applied voltage, the interface asserts a voltage with a first amplitude, less than the applied voltage, in the presence of a detected gas, and asserts a voltage of a lower amplitude in the presence of a detected fire.

7. A detector as in claim 6 wherein the interface asserts the first amplitude for a period of time less than the predetermined value in the presence of the first condition.

8. A detector as in claim 7 wherein the first condition is indicative of a maintenance related condition, different from the presence of the detected gas or the presence of the detected fire.

9. A detector as in claim 8 which includes a connector coupled to the interface, where the connector includes terminals for releasibly coupling the detector to a monitoring loop.

10. A method comprising:
sensing one of the presence of a selected ambient condition, or a trouble indicating condition; and
providing a condition indicating signal having first and second duty cycles where one condition is indicated by an asserted signal having one duty cycle and a second condition is indicated by an asserted signal having another duty cycle.

11. A method as in claim 10 where the provided output signal has a first amplitude, and includes sensing at least the presence of a different ambient condition and providing a second output signal, of a different amplitude indicative thereof.

12. A method as in claim 10 which includes providing a selected voltage which exceeds the amplitude of the asserted signals.

13. A method as in claim 12 which includes reducing the selected voltage to a first value during the one duty cycle in the presence of the one condition and to the first value during the another duty cycle in the presence of the second condition.

14. A method as in claim 13 which includes reducing the selected voltage to a second value, less than the first value in response to detecting a second ambient condition.

15. A system having:
a plurality of detectors with each detector in communication, via a common medium, with a common displaced, control element;
at least some of the detectors each include circuitry that senses the presence of a selected ambient condition, and circuitry to indicate a trouble condition; and
interface circuitry to assert an indicating signal having first and second duty cycles where one condition is indicated by a signal having one duty cycle and the second condition is indicated by another signal having a different duty cycle.

16. A system as in claim 15 where some of the detectors are different than others of the plurality.

17. A system as in claim 16 where some members of the plurality are fire detectors, and others are gas detectors.

18. A system as in claim 17 where the fire detectors assert a signal having a first output amplitude in the presence of fire, and where the gas detectors assert a signal having a different amplitude in the presence of gas, and where at least some of the detectors can indicate a trouble condition by asserting a signal having the different duty cycle.

19. A system as in claim 18 where the control element couples a selected voltage to the detectors via a wired medium, and the asserted signal values are less than the selected voltage.

20. A system as in claim 18 wherein another detector is coupled to the medium and responds to ambient gas.
